(19) United States
(12) Patent Application Publication
(10) Pub. No.: US 2026/0329546 A1
(43) Pub. Date: Oct. 22, 2026

(54) GENERATING EXECUTABLE PACKAGES FROM DESIGN FILES USING GENERATIVE ARTIFICIAL INTELLIGENCE MODELS

(71) Applicant: FIGMA, INC., San Francisco, CA (US)

(72) Inventor: Thomas Joseph GIANNATTASIO, Pittsford, NY (US)

(21) Appl. No.: 19/183,669

(22) Filed: Apr. 18, 2025

(51) Int. Cl. G06F 8/20; G06F 8/60

(52) U.S. Cl. CPC G06F 8/20; G06F 8/60

(57) ABSTRACT

Embodiments of the present disclosure provide techniques for generating an executable package for an application from design files defining workflows in the application in a design environment. An example method generally includes receiving an input prompt specifying a set of design files to convert into an executable package. Using a generative artificial intelligence model, the set of design files are partitioned into a plurality of subsets of design files. Generally, each subset of design files includes topically related design files in the set of design files. Using the generative artificial intelligence model, property data is generated for each respective subset of design files. The executable package is generated based on the plurality of subsets of design files and property data associated with each respective subset of design files. The executable package is deployed to an execution environment.

### BACKGROUND

### Field of the Various Embodiments

Embodiments of the present disclosure relate generally to generating executable packages in a computing system and, more specifically, to techniques for generating executable packages from design files created in a design environment on a computing system.

### Description of the Related Art

Graphic design tools generally allow for the creation of visual assets in a design environment. These visual assets may be defined, for example, as vector assets defined in terms of mathematical relationships between different components or raster assets defined in terms of absolute pixel locations. In some cases, a visual asset may include one or more containers, defined in the vector space, in which raster assets (e.g., images) can be inserted. A visual asset may include any number of visual components, and a visual asset may be defined in terms of relative positioning or other spatial relationships between visual components in the visual asset.

In some cases, the design environment provided by a graphic design tool may be used to generate the visual design of an executable package, such as the visual design of a website including a plurality of web pages implemented in code. Generally, different portions of the executable package may be associated with different executable workflows within an application or website. For example, a first portion of the executable package may correspond to a landing page or the like corresponding to a user interface displayed for an initial state of a website or application. Other portions of the executable package may correspond to portions of the website or application reached when executing various workflows within the website or application.

In some cases, the design environment may be used to generate different visual designs for the same portion of a workflow in the executable package. These different workflows may correspond to workflows executable on different types of devices or within different execution spaces having different screen resolutions or the like. For example, one workflow may correspond to a workflow executable on a desktop computer, laptop computer, tablet computer, etc., while another workflow may correspond to the same workflow executable on a mobile device (e.g., having a resolution below a specified size and having a defined orientation).

Converting design files defining the appearance of an executable package into the executable package is a complex task that often does not result in the creation of a functional executable package. For example, the conversion process may break links between content in different variations of the same portion of the workflow (e.g., a graphic design for the portion of the workflow executed on a desktop and a graphic design for the portion of the workflow executed on a mobile device). In another example, the conversion of the design files defining the appearance of an executable package into the executable package may break links between pages that allow for the layout of a graphical user interface associated with a workflow to change dynamically based on the size of the window or screen on which the graphical user interface is displayed.

As the foregoing illustrates, what is needed are more effective techniques for generating executable packages from design files in a design environment.

### SUMMARY

One embodiment of the present disclosure provides techniques for generating an executable package for an application from design files defining workflows in the application in a design environment. An example method generally includes receiving an input prompt specifying a set of design files to convert into an executable package. Using a generative artificial intelligence model, the set of design files are partitioned into a plurality of subsets of design files. Generally, each subset of design files includes topically related design files in the set of design files. Using the generative artificial intelligence model, property data is generated for each respective subset of design files. The executable package is generated based on the plurality of subsets of design files and property data associated with each respective subset of design files. The executable package is deployed to an execution environment.

One technical advantage of the disclosed techniques relative to the prior art is that the disclosed techniques allow for design files in a design environment to be compiled into a working executable package. The executable package may retain links between components in different, related, graphical user interfaces (e.g., desktop and mobile graphical user interfaces associated with the same workflow in an application) and may retain breakpoint information that allows for the layout of the graphical user interface rendered on a client device to dynamically adjust to the size of the window on which the graphical user interface is rendered, the type of device on which the graphical user interface is rendered, and so on. By doing so, embodiments presented herein may more efficiently generate executable packages from design files than techniques for generating executable packages from design files that rely on duplication of content across design files. Further, embodiments presented herein may generate executable packages that are executable across different execution environments without losing functionality that would be lost when links between different components in design files are lost during duplication across design files.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present disclosure.

FIG. 2 illustrates an example of partitioning design files into a plurality of subsets of design files corresponding to unique portions of a workflow implemented in an executable package, according to some embodiments.

FIG. 3 is a flow diagram illustrating example operations for generating an executable package from a set of design files using a generative artificial intelligence model, according to some embodiments.

FIG. 4 illustrates a network computing system to implement an interactive graphic application platform, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

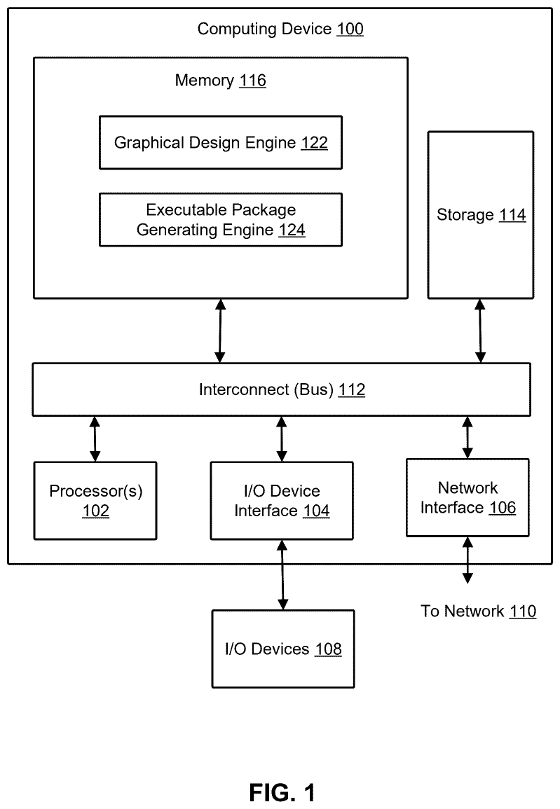

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run graphical design engine 122 and executable package generating engine 124 that reside in a memory 116.

It is noted that the computing device described herein is illustrative and that any other technically feasible configurations fall within the scope of the present disclosure. For example, multiple instances of graphical design engine 122 and/or executable package generating engine 124 could execute on a set of nodes in a distributed and/or cloud computing system to implement the functionality of computing device 100. In another example, graphical design engine 122 and/or executable package generating engine 124 could execute on various sets of hardware, types of devices, or environments to adapt graphical design engine 122 and/or executable package generating engine 124 to different use cases or applications. In a third example, graphical design engine 122 and/or executable package generating engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. graphical design engine 122 and executable package generating engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including graphical design engine 122 and executable package generating engine 124.

### Example Generating Executable Packages From Design Files Using Generative Artificial Intelligence Models

Generally, a design environment such as that hosted by graphical design engine 122 allows for the creation of graphical user interfaces and, in some cases, functionality attached to different portions of the graphical user interfaces. These graphical user interfaces may be created for different portions of a workflow executed in an application, by navigating a web site including a plurality of web pages, or the like. Generally, the design environment allows for different design files to be created and visualized in a staging or design environment that is isolated from an execution environment in which the completed graphical user interfaces and associated functionality is eventually to be deployed.

In some cases, the design environment hosted by graphical design engine 122 may be used to create, on the same canvas or in the same workspace, different graphical user interfaces for the same portion of a workflow executed in an application. For example, a desktop graphical user interface for a workflow may be designed on the same canvas or in the same workspace as a mobile graphical user interface for the same workflow. In such a case, various breakpoints may be defined for these different variations of the same portion of a workflow. Using an example of graphical user interface for a workflow having a desktop version and a mobile version, a breakpoint may be defined to determine which version of the graphical user interface is displayed. Generally, when a window is sized to a dimension smaller than the defined breakpoint (e.g., when the window width is reduced in size to a size smaller than a defined size), the execution environment may render the mobile version of the graphical user interface. Meanwhile, when a window is sized to a dimension larger than the defined breakpoint, the execution environment may render the desktop version of the graphical user interface. Additional breakpoints may be defined, for example, for different sub-versions of the mobile version of the graphical user interface and/or the desktop version of the graphical user interface (e.g., to accommodate different screen dimensions, such as narrower screens, wider screens, etc.).

As discussed, generating an executable package from design files created in a design environment hosted by graphical design engine 122 generally involves the creation of multiple design files for each portion of a workflow and conversion of each of these design files into an executable format. Generally, different variations of the same portion of a workflow may be defined in the design environment as separate design files associated with these different variations. Elements within different design files associated with different variations of the workflow may be linked together so that elements can be resized and repositioned dynamically as the layout of a graphical user interface for the workflow changes (e.g., due to changes in the size of a screen or window in which the workflow is executed). However, as discussed above, converting design files into an executable package based on duplication of design files generally results in the creation of executable workflows that do not work as expected. For example, these workflows may not change layout when breakpoints are encountered, may not re-render visual elements correctly due to the loss of (or lack of) links between related visual assets during the duplication process, and the like.

To convert a set of design files into a functional executable package, embodiments presented herein provide techniques for converting design files into an executable package based on a generative artificial intelligence model and organization of design files into related subsets of files. Generally, a generative artificial intelligence model can identify related design files and build links between related visual assets (and their related data bindings, etc.) in related design files in response to a prompt to generate an executable package. The generative artificial intelligence model can also generate properties applicable to related design files, such as a title, a path, and links to other design files in the executable package and use the generated properties to build an executable package that is executable across various execution environments. By doing so, embodiments of the present disclosure allow for rapid deployment of executable packages from design files and generate executable packages that include the correct functionality regardless of the environment in which the executable package is executed.

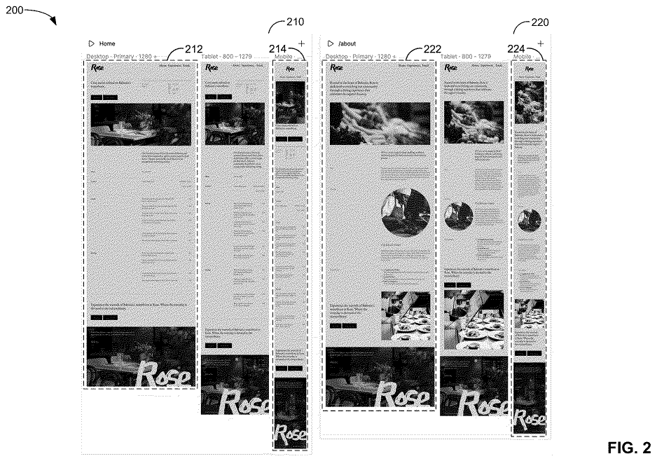

FIG. 2 illustrates an example of partitioning design files rendered in a design environment 200 into a plurality of subsets of design files corresponding to unique portions of a workflow implemented in an executable package, according to some embodiments.

In design environment 200, a plurality of design files may be generated to visualize the appearance of graphical user interfaces associated with different portions of a workflow to be implemented in an executable package. The design files may include a design file 212 corresponding to a desktop variant and a design file 214 corresponding to a mobile variant of a first portion of the workflow (e.g., a landing page, home screen, etc. to which a user of the executable package is directed in order to begin interaction with an application), a design file 222 corresponding to a desktop variant and design file 224 corresponding to a mobile variant of a second portion of the workflow, and so on. Generally, the desktop variant and the mobile variant of a portion of a workflow may include similar content in a different layout. For example, the desktop variant may have a layout that takes advantage of the width of the display on which the graphical user interface of the executable package is displayed (e.g., may have a layout that is larger on the width dimension than on the height dimension). In contrast, the mobile variant may have an advance that is restricted by the width of the display on which the graphical user interface of the executable package is displayed (e.g., may have a layout that is larger on the height dimension than on the width dimension). In some embodiments, different variants of the graphical user interface may be defined based on a pixel density of a display on which the graphical user interface is rendered. It should be recognized, however, that the foregoing are examples of different user interface layouts and variants of a workflow that can be generated in design environment 200, and other types of variants (e.g., based on other properties of a device on which the executable environment is deployed) may be contemplated.

Executable package generating engine 124 generally uses a generative artificial intelligence model to convert a set of design files rendered in a design environment hosted by graphical design engine 122 into an executable package for deployment in an execution environment. To generate the executable package for deployment in the execution environment, executable package generating engine 124 generates an input prompt for execution by a generative artificial intelligence model that specifies the design files to be organized into an executable package and, in some embodiments, describes rules for organizing the design files into the executable package. For example, the rules specified in the input prompt may specify how the generative artificial intelligence model determines that two design files are matching files (e.g., based on string similarity, etc.), whether the matching is structure-dependent or structure-invariant, or the like.

The generative artificial intelligence model used by executable package generating engine 124 ingests the input prompt and design files (e.g., design files 212, 214, 222, 224, amongst others not illustrated in FIG. 2) and divides the design files into a plurality of subsets of design files according to the rules defined in the input prompt. To divide the design files into the plurality of subsets of design files, executable package generating engine 124 can perform a pairwise comparison of design files to identify matching design files. Generally, matching design files may be design files that represent different variants of the same portion of a workflow. For example, these different variants may be different designs allowing for execution of the same portion of the workflow on different devices. To determine whether a first design file in the design environment is a match to a second design file in the design environment, the generative artificial intelligence model can compare the textual content, visual content, and structure of the design files.

In comparing the textual content of a first design file and a second design file in a pairwise comparison, executable package generating engine 124 can attempt to match strings in the first design file and the second design file. Generally, the matching of strings may be a position and structure-invariant; that is, strings may be identified as matching strings regardless of the location of a string in a design file. In some embodiments, executable package generating engine 124 can determine that a string in the first design file is a match to a corresponding string in the second design file based on fuzzy matching or partial matching techniques. For example, if the content of a string in the first design file and the content of a corresponding string in the second design file has a matching score equal to or above a threshold score, executable package generating engine 124 can determine that the strings are matching strings.

The generative artificial intelligence model used by executable package generating engine 124 can, as discussed above, determine whether a first design file and a second design file are matching design files based on matches between different visual properties or other visual assets in these files. To do so, executable package generating engine 124 can identify visual properties of visual components in the first design file, such as colors, fills, line strokes, shapes, and the like, and attempt to identify matching visual components in the second design file. Executable package generating engine 124 can compare the visual properties of a visual component in the first design file to properties of visual components in the second design file to identify visual components with similar properties. In some embodiments, executable package generating engine 124 can determine whether a visual component in a first design file is a match to a corresponding visual component in a second design file may be performed based on applying a scaling factor to size parameters or otherwise normalizing the size of visual components across different design files.

In some embodiments, executable package generating engine 124 uses the generative artificial intelligence model to compare the structure of visual components in the first design file and the second design file to determine whether the first design file and the second design file are matches. To do so, executable package generating engine 124 can compare a tree representation of the first design file to a tree representation of the second design file. Generally, executable package generating engine 124 can determine that the structure of visual components in the first and the second design files match based on parent-child relationships between different visual components in the tree representations.

Generally, executable package generating engine 124 uses the generative artificial intelligence model to generate matching scores between different design files in the design environment hosted by graphical design engine 122. The matching scores may be based, as discussed above, on textual, visual, and structural comparisons between design files in the design environment. Higher matching scores generally indicate a closer match between two design files, while lower matching scores generally indicate that two design files are different (e.g., correspond to different portions of a workflow). For example, as illustrated in FIG. 2, executable package generating engine 124 can identify the design files 212 and 214, corresponding to a landing page or initial portion of a workflow, as a first subset of similar design files. Meanwhile, executable package generating engine 124 can identify the design files 222 and 224, corresponding to a subsequent page or subsequent portion of a workflow, as a second subset of similar design files. Based on the matching scores, executable package generating engine 124 can thus partition the design files in the design environment into a plurality of subsets of design files (e.g., a first subset 210 and a second subset 220). Each subset of design files may generally correspond to matching design files for a particular portion of a workflow to be implemented in the executable package.

To allow for dynamic rendering of the different variations of a workflow illustrated by different design files in a subset of design files 210, 220, executable package generating engine 124 can generate links between corresponding visual components in each design file in a given subset of design files. Generally, executable package generating engine 124 can use the matching data used in generating match scores between design files to identify matching components in a first design file (e.g., design file 212) and a second design file (e.g., design file 214). For example, textual components including common text illustrated in the first design file 212 and the second design file 214 may be linked. Executable package generating engine 124 can, in some embodiments, generate links between components in design files recursively or based on parent-child relationships of components in the design files. In some embodiments, where executable package generating engine 124 does not identify a component in a first design file with a matching component in a second design file, executable package generating engine 124 can generate a hidden component in the second design file. Executable package generating engine 124 can generate the hidden component in the second design file by cloning the component from the first design file and hiding the cloned component in the second design file. After the hidden component is generated, executable package generating engine 124 can generate a link between the component in the first design file and the hidden component in the second design file, thereby maintaining a 1-to-1 relationship between components in design files in any subset of design files 210, 220.

In some embodiments, executable package generating engine 124 can generate common names for matching components in design files within a subset of design files 210, 220 (amongst others not illustrated in FIG. 2). The common name may be a shared identifier, such as a globally unique identifier, a string describing a component, or the like. By generating a common name for matching components in design files, subsequent matching operations may rely on the common name to identify matching components in generating an updated executable package.

For each subset of design files 210, 220 (amongst others not illustrated in FIG. 2), executable package generating engine 124 generates, using the generative artificial intelligence model, property data that is used to generate the executable package. Generally, the property data may include data such as a title associated with each subset of design files 210, 220, an access path associated with each subset of design files 210, 220, links to other subsets of design files, and so on. In some embodiments, executable package generating engine 124 the property data may be generated based on the content of the subsets of design files 210, 220 and other contextual information, such as links between different design files or the like. For example, the design files 212, 214 in the first subset of design files 210, as illustrated, includes a broad range of content and other contextual information indicative that the first subset of design files 210 is an initial landing page. Thus, the generative artificial intelligence model can generate a title for the first subset of design files 210 indicating that the first subset of design files 210 represents a home page or landing page for a workflow. Similarly, the content of the second subset of design files 220 as illustrated is associated with a specific item. Thus, the generative artificial intelligence model used by executable package generating engine 124 can assign the second subset of design files 220 a title indicating that the second subset of design files 220 corresponds to a product page.

Subsequently, executable package generating engine 124 uses the subsets of design files 210, 220 (amongst others not illustrated in FIG. 2) and the properties generated by the generative artificial intelligence model to generate the executable package. In some embodiments, executable package generating engine 124 can generate a text file or other parseable file (e.g., a manifest) identifying the structure of the executable package based on which the design files are packaged and deployed to the executable environment. For example, in an embodiment in which the executable package is a website including a plurality of webpages, the structure of the executable package may include information identifying an access path and design files associated with the access path. In deploying the executable package, executable package generating engine 124 can generate a logical access structure as identified in the text file in the execution environment. Executable package generating engine 124 can then deploy executable files generated from design files to the appropriate logical path.

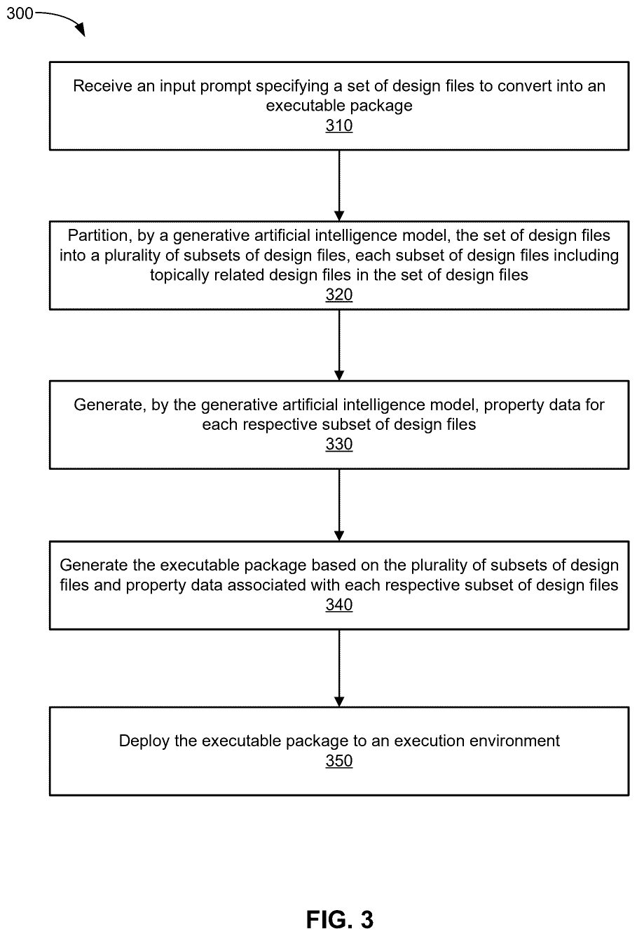

FIG. 3 is a flow diagram of operations 300 for generating an executable package from a set of design files using a generative artificial intelligence model, according to some embodiments. Operations 300 may be performed, for example, by an executable package generator that ingests a set of design files, organizes design files into related groups of design files, and generates an executable package from the groups of design files, such as executable package generating engine 124 illustrated in FIG. 1.

As illustrated, operations 300 begin at block 310, where executable package generating engine 124 receives an input prompt specifying a set of design files to convert into an executable package. In some embodiments, the input prompt may specify rules for determining whether design files in the set of design files are matching files, rules for generating properties for these design files, and so on. In some embodiments, the input prompt may be generated based on concatenating an a priori defined prompt with a set of design files identified in a design environment in which the design files are rendered.

At block 320, executable package generating engine 124 partitions, using a generative artificial intelligence model, the set of design files into a plurality of subsets of design files. Generally, each subset of design files may include topically related design files in the set of design files.

In some embodiments, to partition the set of design files into the plurality of subsets of design files, executable package generating engine 124 generates, using the generative artificial intelligence model, a respective text representation for each respective design file in the set of design files. Executable package generating engine 124 can identify matching design files to include in a subset of design files based on determining that a first text representation associated with a first design file in the set of design files and a second text representation associated with a second design file in the set of design files has a similarity metric above a threshold similarity metric. In some embodiments, the respective text representation for a respective design file in the set of design files comprises a description of a hierarchical structure in which visual elements are defined in the respective design file and a description of content included in the visual elements defined in the respective design file.

In some embodiments, to partition the set of design files into the plurality of subsets of design files, executable package generating engine 124 generates a matching score between strings in a first design file in the set of design files and a second design file in the set of design files. Executable package generating engine 124 can include the first design file and the second design file in a subset of design files based on the matching score between the strings in the first design file and the second design file exceeding a threshold score. In some embodiments, the threshold score may be defined in the input prompt. Generally, in generating the matching score between strings in the first and second design files, executable package generating engine 124 can match strings in a location-invariant manner.

In some embodiments, to partition the set of design files into the plurality of subsets of design files, executable package generating engine 124 generates a matching score based on a comparison of visual assets in a first design file and corresponding visual assets in a second design file. Executable package generating engine 124 can include the first design file and the second design file in a subset of design files based on the matching score exceeding a threshold score.

In some embodiments, to partition the set of design files into the plurality of subsets of design files, executable package generating engine 124 determines that a structure of a first design file is similar to a structure of a second design file. For example, executable package generating engine 124 can compare a tree structure identifying parent-child relationships between different visual components in a first design file to a corresponding tree structure for a second design file and determine whether the first and second design files are similar based on the comparison of tree structures. Executable package generating engine 124 can include the first design file and the second design file in a subset of design files based on the determining.

In some embodiments, each subset of design files may include design files associated with breakpoints at which a visual layout of a design changes from a first layout associated with a first set of window dimensions in which a design is rendered to a second layout associated with a second set of window dimensions in which the design is rendered.

At block 330, executable package generating engine 124 generates, using the generative artificial intelligence model, property data for each respective subset of design files.

At block 340, executable package generating engine 124 generates the executable package based on the plurality of subsets of design files and property data associated with each respective subset of design files.

In some embodiments, to generate the executable package, executable package generating engine 124 links matching nodes across design files in each of the respective subset of design files. Executable package generating engine 124 generates hidden nodes in a first design file in the respective subset of design files corresponding to unmatched nodes in a second design file in the respective subset of design files. In some embodiments, as discussed above, executable package generating engine 124 generates a hidden node in a first design file by cloning an unmatched node in the second design file in the first design files and hiding the cloned node in the first design file.

In some embodiments, executable package generating engine 124 links matching nodes across design files in the respective subset of design files by defining a set of nodes in a first design file in the respective subset of design files as a reference set of nodes. For each respective node in the reference set of nodes, executable package generating engine 124 identifies a respective corresponding node in at least a second design file in the respective subset of design files based on similarities between properties of the respective node and the respective corresponding node. Executable package generating engine 124 connects the respective node in the first design file to the respective corresponding node in the second design file.

In some embodiments, the properties based on which the respective corresponding node is identified may include one or more of textual content, visual properties, or structural properties associated with a node.

In some embodiments, the operations 300 further include generating a common name for the respective node and the respective corresponding node.

At block 350, executable package generating engine 124 deploys the executable package to an execution environment.

In some embodiments, executable package generating engine 124 assigns, using the generative artificial intelligence model, a path name and a title to each respective subset of design files based on content of design files. Executable package generating engine 124 generates a manifest for the executable package based on the path name and title assigned to each respective subset of design files.

In some embodiments, the executable package comprises a website defined based on the path name assigned to each respective subset of design files. To deploy the executable package, executable package generating engine 124 deploys the website to a server or other execution environment based on the path name assigned to each respective subset of design files.

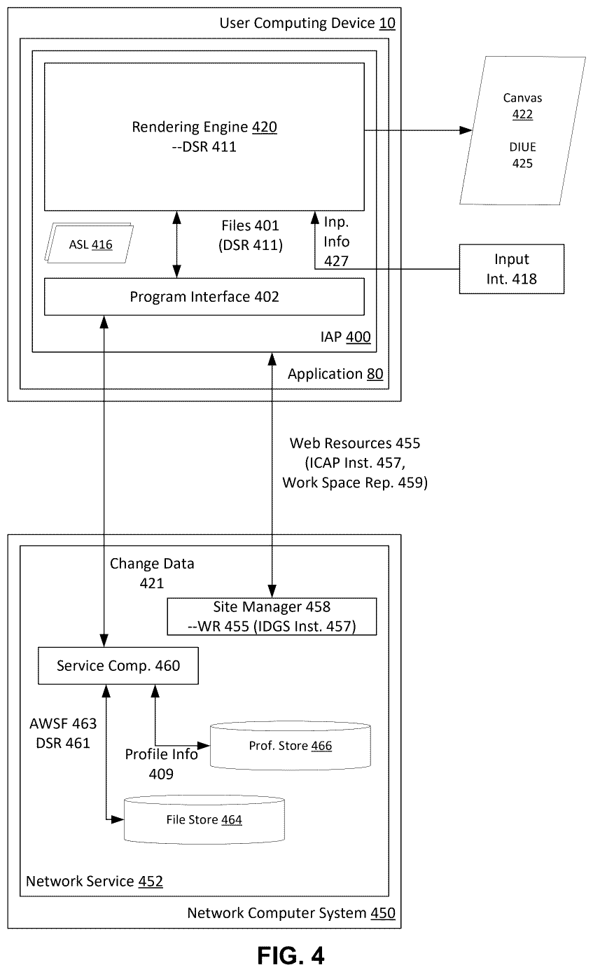

FIG. 4 illustrates a network computing system to implement an interactive application platform on a user computing device, according to some embodiments. A network computing system such as illustrated in FIG. 4 can be implemented using one or more servers which communicate with user computing devices over one or more networks. The network computer system 450 illustrated in FIG. 4 may correspond, for example, to the computing device 100 illustrated in FIG. 1 and can be used to graphical design engine 122 and executable package generating engine 124.

In some embodiments, the network computing system 450 performs operations to enable an interactive application platform (“IAP 400”) to be implemented on user computing devices 10. In some embodiments, the IAP 400 can be implemented by the user initiating a session (e.g., user accessing a website) to receive programmatic resources of the IAP 400. A browser component executes the programmatic resources to implement the IAP 400, with functionality to receive user input and to render content that is based on or responsive to user input. As described, the IAP 400 is implemented to enable the user to create various types of content, such as interactive graphic designs, art, whiteboard content, program code renderings, presentations, and/or textual content. As further described, the IAP 400 can include logic (“ASL 416”) for implementing one or more application services, where each application service is implemented through the IAP 400 to provide a corresponding set of functionality and user experience. The IAP 400 also implements the application services to share some resources, such as the canvas, workspace file or library of design elements. Further, the IAP 400 enables multiple application services to be used during a given online session and/or with respect to a particular application service.

According to some embodiments, a user of computing device 10 operates web-based application 80 to access a network site, where programmatic resources are retrieved and executed to implement the IAP 400. The web-based application 80 can execute scripts, code and/or other logic (the “programmatic components”) to implement functionality of the IAP 400. In some embodiments, the web-based application 80 can correspond to a commercially available browser, such as GOOGLE CHROME (developed by GOOGLE, INC.) or SAFARI (developed by APPLE, INC.). In some embodiments, the processes of the IAP 400 can be implemented as scripts and/or other embedded code which web-based application 80 downloads from a network site. For example, the web-based application 80 can execute code that is embedded within a webpage to implement processes of the IAP 400. The web-based application 80 can also execute the scripts to retrieve other scripts and programmatic resources (e.g., libraries) from the network site and/or other local or remote locations. By way of example, the web-based application 80 may execute JAVASCRIPT embedded in an HTML resource (e.g., web-page structured in accordance with HTML 5.0 or other versions, as provided under standards published by W3C or WHATWG consortiums). In some embodiments, the rendering engine 420 may utilize graphics processing unit (GPU) accelerated logic, such as provided through WebGL (Web Graphics Library) programs which execute Graphics Library Shader Language (GLSL) programs that execute on GPUs.

The IAP 400 can be implemented as part of a network service, where web-based application 80 communicates with one or more remote computers (e.g., server used for a network service) to execute processes of the IAP 400. The web-based application 80 retrieves some or all of the programmatic resources for implementing the IAP 400 from a network site. The web-based application 80 may also access various types of data sets in providing the IAP 400. The data sets can correspond to files and design libraries (e.g., predesigned design elements), which can be stored remotely (e.g., on a server, in association with an account) or locally. In some embodiments, the network computer system 450 provides a shared design library which the user computing device 10 can use with any of the application services provided through the IAP 400. In this way, the user may initiate a session to implement the IAP 400 for the purpose of creating or editing the workspace file, as rendered on the canvas 422, in accordance with one of multiple collaborative application services of the IAP 400.

In some embodiments, the IAP 400 includes a program interface 402, an input interface 418 and a rendering engine 420. The program interface 402 can include one or more processes which execute to access and retrieve programmatic resources from local and/or remote sources. In an implementation, the program interface 402 can generate, for example, a canvas 422, using programmatic resources which are associated with web-based application 80 (e.g., HTML 5.0 canvas). As an addition or variation, the program interface 402 can trigger or otherwise cause the canvas 422 to be generated using programmatic resources and data sets (e.g., canvas parameters) which are retrieved from local (e.g., memory) or remote sources (e.g., from network service).

The program interface 402 may also retrieve programmatic resources that include an application framework for use with canvas 422. The application framework can include data sets which define or configure, for example, a set of interactive graphic tools that integrate with the canvas 422 and which comprise the input interface 418, to enable the user to provide input to generate or update content rendered on the canvas 422.

According to some embodiments, the input interface 418 can be implemented as a functional layer that is integrated with the canvas 422 to detect and interpret user input. The input interface 418 can, for example, process a user's interaction with an input mechanism (e.g., pointer device, keyboard) of the user computing device, to detect, for example, cursor positioning/movement with respect to the canvas 422, hover input (e.g., pre-selection input), selection input (e.g., clicks or double clicks), shortcuts (e.g., keyboard inputs) and other inputs. In processing a user's interaction with a pointer device, the input interface 418 can use a reference of the canvas 422 to identify a screen location of a user's cursor as the user moves or otherwise interacts with the pointer device. Additionally, the input interface 418 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In some embodiments, the input interface 418 can interpret, for example, a series of inputs as a design tool selection (e.g., shape selection based on location of input), as well as inputs to define attributes (e.g., dimensions) of a selected shape. In some embodiments, the input interface 418 can interpret a continuous input (corresponding to a continuous movement of the user's pointer device) as selecting a tool (e.g., shape too) and canvas location where an output of the selected tool is to appear.

In some embodiments, the IAP 400 includes application service logic 416 to enable multiple application services to be utilized during a given user session, where each application service provides the user with a particular functionality and/or user experience. As described by some embodiments, each application service is implemented by the IAP 400 utilizing a corresponding application service logic 416 to configure the interface component 418, rendering engine 420 and/or other components of the IAP 400 to provide the functionality and user experience of the corresponding application service. In this way, the IAP 400 enables the user to operate multiple application services during one online session. Further, the different application services can share resources, including programmatic resources of the IAP 400, such as canvas 422. In this way, each application service can contribute content to and/or utilize features and content provided with the canvas 422 during a given session. Still further, the application services can be implemented as alternative modalities of IAP 400, such that the user can toggle between modes, where each mode provides a particular functionality and user experience. In some embodiments, each application service can utilize a common workspace file associated with the user. By default, a computing device that opens the workspace file can utilize a default application service to access and/or update that workspace file. The user may also switch the mode of operation of the IAP 400 to utilize a different application service to access, use and/or update the workspace file.

The network computing system 450 can include a site manager 458 to manage a website where a set of web-resources 455 (e.g., web page) are made available for the web-based application 80 of user computing devices 10. The web-resources 455 can include instructions, such as scripts or other logic (“ICAP instructions 457”), which are executable by browsers or web components of user computing devices. The web resources 455 can also include (i) resources that are to be shared as between application services, provided to the user computing devices in connection with the user computing devices utilizing either of the application services, and (ii) application specific resources, which execute on the user computing devices for a particular one of the available application services. The web resources 455 can also include a design library of design elements that is partially or fully shared as between the application services. The library of design elements can enable the user to select predetermined design elements for use on the canvas 422 in connection with the user utilizing either of the application services.

In some variations, once the computing device 10 accesses and downloads the web-resources 455, web-based application 80 executes the ICAP instructions 457 to implement functionality as described above. For example, the ICAP instructions 457 can be executed by web-based application 80 to initiate the program interface 402 on the user computing device 10. The initiation of the program interface 402 may coincide with the establishment of, for example, a web-socket connection between the program interface 402 and a service component 460 of the network computing system 450.

In some embodiments, the web-resources 455 includes logic which web-based application 80 executes to initiate one or more processes of a program interface 402, causing the IAP 400 to retrieve additional programmatic resources and data sets for implementing functionality as described by examples. The web resources 455 can, for example, embed logic (e.g., JAVASCRIPT code), including GPU accelerated logic, in an HTML page for download by computing devices of users. The program interface 402 can be triggered to retrieve additional programmatic resources and data sets from, for example, the network service 452, and/or from local resources of the computing device 10, in order to implement each of the multiple application services of the IAP 400. For example, some of the components of the IAP 400 can be implemented through web pages that can be downloaded onto the computing device 10 after authentication is performed, and/or once the user performs additional actions (e.g., download one or more pages of the workspace associated with the account identifier). Accordingly, in examples as described, the network computing system 450 can communicate the ICAP instructions 457 to the computing device 10 through a combination of network communications, including through downloading activity of web-based application 80, where the ICAP instructions 457 are received and executed by web-based application 80.

The computing device 10 can use web-based application 80 to access a website of the network service 452 to download the webpage or web resource. Upon accessing the website, web-based application 80 can automatically (e.g., through saved credentials) or through manual input, communicate an account identifier to the service component 460. In some embodiments, web-based application 80 can also communicate one or more additional identifiers that correlate to a user identifier.

Additionally, in some embodiments, the service component 460 can use the user or account identifier of the user identifier to retrieve profile information 409 from a user profile store 466. As an addition or variation, profile information 409 for the user can be determined and stored locally on the user's computing device 10.

The service component 460 can also retrieve the files of an active workspace (“active workspace files 463”) that are linked to the user account or identifier from a file store 464. The profile store 466 can also identify the workspace that is identified with the account and/or user, and the file store 464 can store the data sets that comprise the workspace. The data sets stored with the file store 464 can include, for example, the pages of a workspace and one or more data structure representations 461 for the design under edit which is renderable from the respective active workspace files.

As an addition or variation, each file can be associated with metadata that identifies the application service that was used to create the particular file. In some embodiments, the metadata identifies the default application service for viewing, utilizing or otherwise updating the application service.

Additionally, in some embodiments, the service component 460 provides a representation 459 of the workspace associated with the user to the web-based application 80, where the representation identifies, for example, individual files associated with the user and/or user account. The workspace representation 459 can also identify a set of files, where each file includes one or multiple pages, and each page including objects that are part of a design interface.

On the user device 10, the user can view the workspace representation through web-based application 80, and the user can elect to open a file of the workspace through web-based application 80. In some embodiments, upon the user electing to open one of the active workspace files 463, web-based application 80 initiates the canvas 422. For example, the IAP 40 can initiate an HTML 5.0 canvas as a component of web-based application 80, and the rendering engine 120 can access one or more data structures representations 411 of content rendered on the canvas 422.

The IAP 400 utilizes application service logic 416 to implement multiple modes of operation, where each mode corresponds to an application service. As described, the application service logic 416 associated with each service application can include instructions and data for configuring the components of IAP 400 to include functionality and features of the corresponding application service. Accordingly, the application service logic 416 can, for example, configure the application framework and/or input interface 418 to differ in form, functionality and/or configuration as between the alternative modes of the IAP 400. Additionally, the type of actions and interactions which the user can perform to register input can vary based on the modes of operation. Still further, the different modes of operation can include different input or user-interface features for the user to select and use for inclusion on the canvas 422. By way of example, when the IAP 400 is operating in a mode for whiteboarding service application, the program interface 402 can provide input features to enable a user to select a design element that is in the form of a “sticky note,” while in an alternative mode for an interactive graphic design service application, the “sticky note feature” is not available. However, in the alternative mode, the user may be able to select anyone of numerous possible shapes or previously designed objects which the user can write textual messages in for display on the canvas 422.

Additionally, the application service logic 416 can configure the operation of the rendering engine 420, such that the functionality and behavior of the rendering engine 420 differs as between different application services. In this way, the rendering engine 420 functions to provide alternative behaviors for different modes of operation, coinciding with the particular service application that is active. By way of example, the configuration of the rendering engine 420 can affect the appearance of the canvas 422, the appearance (e.g., visual attributes) of rendered content elements on the canvas 422, the behavior or representation of user interaction (e.g., whether the user cursor or pointer device is represented on the canvas 422), the type or specific content that is rendered, the physics engine that is used by the rendering engine to represent dynamic events (e.g., the object being moved), what user operations can be performed (e.g., whether select objects can be resized), and the like.

Additionally, each of the application services can utilize a shared library of content elements (e.g., graphic design element), as well as core functionality that enables design elements to be shared and updated between the different application services that are available through the platform. Additionally, the workspace file created and edited through use of one application service can be utilized with the other application service. Moreover, the transition between application services can be seamless—for example, the user computing device 10 can open a workspace file using the first application service (e.g., interactive graphic design application service for UIX design) then seamlessly switch to using the second application service (e.g., whiteboarding application service) with the same file, without closing the workspace file. In some embodiments, each application service enables the user to update the workspace file even while the workspace file is in use by other computing devices (e.g., such as in a collaborative environment). In some embodiments, the user can mode switch the IAP 400 to switch which application service is in use, with each application service utilizing the workspace file.

### Example Clauses

Various aspects of the present disclosure are described in the following numbered clauses.
1. In some embodiments, a processor-implemented method, comprising: receiving an input prompt specifying a set of design files to convert into an executable package; partitioning, by a generative artificial intelligence model, the set of design files into a plurality of subsets of design files, each subset of design files including topically related design files in the set of design files; generating, by the generative artificial intelligence model, property data for each respective subset of design files; generating the executable package based on the plurality of subsets of design files and property data associated with each respective subset of design files; and deploying the executable package to an execution environment.
2. The method of clause 1, wherein partitioning the set of design files into the plurality of subsets of design files comprises: generating, using the generative artificial intelligence model, a respective text representation for each respective design file in the set of design files; and identifying matching design files to include in a subset of design files based on determining that a first text representation associated with a first design file in the set of design files and a second text representation associated with a second design file in the set of design files has a similarity metric above a threshold similarity metric.
3. The method of clause 2, wherein the respective text representation for a respective design file in the set of design files comprises a description of a hierarchical structure in which visual elements are defined in the respective design file and a description of content included in the visual elements defined in the respective design file.
4. The method of any of clauses 1 through 3, wherein partitioning the set of design files into the plurality of subsets of design files comprises: generating a matching score between strings in a first design file in the set of design files and a second design file in the set of design files; and including the first design file and the second design file in a subset of design files based on the matching score between the strings in the first design file and the second design file exceeding a threshold score.
5. The method of any of clauses 1 through 4, wherein partitioning the set of design files into the plurality of subsets of design files comprises: generating a matching score based on a comparison of visual assets in a first design file and corresponding visual assets in a second design file; and including the first design file and the second design file in a subset of design files based on the matching score exceeding a threshold score.
6. The method of any of clauses 1 through 5, wherein partitioning the set of design files into the plurality of subsets of design files comprises: determining that a structure of a first design file is similar to a structure of a second design file; and including the first design file and the second design file in a subset of design files based on the determining.
7. The method of any of clauses 1 through 6, wherein generating the executable package comprises, for each respective subset of design files: linking matching nodes across design files in the respective subset of design files; and generating hidden nodes in a first design file in the respective subset of design files corresponding to unmatched nodes in a second design file in the respective subset of design files.
8. The method of clause 7, wherein linking matching nodes across design files in the respective subset of design files comprises: defining a set of nodes in a first design file in the respective subset of design files as a reference set of nodes; for each respective node in the reference set of nodes, identifying a respective corresponding node in at least a second design file in the respective subset of design files based on similarities between properties of the respective node and the respective corresponding node; and connecting the respective node in the first design file to the respective corresponding node in the second design file.
9. The method of clause 8, wherein the properties based on which the respective corresponding node is identified includes one or more of textual content, visual properties, or structural properties associated with a node.
10. The method of any of clauses 8 or 9, further comprising generating a common name for the respective node and the respective corresponding node.
11. The method of any of clauses 1 through 10, wherein each subset of design files comprises design files associated with breakpoints at which a visual layout of a design changes from a first layout associated with a first set of window dimensions in which a design is rendered to a second layout associated with a second set of window dimensions in which the design is rendered.
12. The method of any of clauses 1 through 11, wherein generating the executable package comprises: assigning, by the generative artificial intelligence model, a path name and a title to each respective subset of design files based on content of design files; and generating a manifest for the executable package based on the path name and title assigned to each respective subset of design files.
13. The method of clause 12, wherein: the executable package comprises a website defined based on the path name assigned to each respective subset of design files; and deploying the executable package to the execution environment comprises deploying the website to a server based on the path name assigned to each respective subset of design files.
14. A processing system, comprising: at least one memory having executable instructions thereon; and one or more processors configured to execute the executable instructions to cause the processing system to perform the method of any of clauses 1 through 13.
15. A processing system, comprising: means for performing the method of any of clauses 1 through 13.
16. A non-transitory computer-readable medium having executable instructions stored thereon which, when processed by one or more processors, causes the one or more processors to perform the method of any of clauses 1 through 13.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A processor-implemented method, comprising:
receiving an input prompt specifying a set of design files to convert into an executable package;
partitioning, by a generative artificial intelligence model, the set of design files into a plurality of subsets of design files, each subset of design files including topically related design files in the set of design files;
generating, by the generative artificial intelligence model, property data for each respective subset of design files;
generating the executable package based on the plurality of subsets of design files and property data associated with each respective subset of design files; and
deploying the executable package to an execution environment.

2. The method of claim 1, wherein partitioning the set of design files into the plurality of subsets of design files comprises:
generating, using the generative artificial intelligence model, a respective text representation for each respective design file in the set of design files; and
identifying matching design files to include in a subset of design files based on determining that a first text representation associated with a first design file in the set of design files and a second text representation associated with a second design file in the set of design files has a similarity metric above a threshold similarity metric.

3. The method of claim 2, wherein the respective text representation for a respective design file in the set of design files comprises a description of a hierarchical structure in which visual elements are defined in the respective design file and a description of content included in the visual elements defined in the respective design file.

4. The method of claim 1, wherein partitioning the set of design files into the plurality of subsets of design files comprises:
generating a matching score between strings in a first design file in the set of design files and a second design file in the set of design files; and
including the first design file and the second design file in a subset of design files based on the matching score between the strings in the first design file and the second design file exceeding a threshold score.

5. The method of claim 1, wherein partitioning the set of design files into the plurality of subsets of design files comprises:
generating a matching score based on a comparison of visual assets in a first design file and corresponding visual assets in a second design file; and
including the first design file and the second design file in a subset of design files based on the matching score exceeding a threshold score.

6. The method of claim 1, wherein partitioning the set of design files into the plurality of subsets of design files comprises:
determining that a structure of a first design file is similar to a structure of a second design file; and
including the first design file and the second design file in a subset of design files based on the determining.

7. The method of claim 1, wherein generating the executable package comprises, for each respective subset of design files:
linking matching nodes across design files in the respective subset of design files; and
generating hidden nodes in a first design file in the respective subset of design files corresponding to unmatched nodes in a second design file in the respective subset of design files.

8. The method of claim 7, wherein linking matching nodes across design files in the respective subset of design files comprises:
defining a set of nodes in a first design file in the respective subset of design files as a reference set of nodes;
for each respective node in the reference set of nodes, identifying a respective corresponding node in at least a second design file in the respective subset of design files based on similarities between properties of the respective node and the respective corresponding node; and
connecting the respective node in the first design file to the respective corresponding node in the second design file.

9. The method of claim 8, wherein the properties based on which the respective corresponding node is identified includes one or more of textual content, visual properties, or structural properties associated with a node.

10. The method of claim 8, further comprising generating a common name for the respective node and the respective corresponding node.

11. The method of claim 1, wherein each subset of design files comprises design files associated with breakpoints at which a visual layout of a design changes from a first layout associated with a first set of window dimensions in which a design is rendered to a second layout associated with a second set of window dimensions in which the design is rendered.

12. The method of claim 1, wherein generating the executable package comprises:
assigning, by the generative artificial intelligence model, a path name and a title to each respective subset of design files based on content of design files; and
generating a manifest for the executable package based on the path name and title assigned to each respective subset of design files.

13. The method of claim 12, wherein:
the executable package comprises a website defined based on the path name assigned to each respective subset of design files; and
deploying the executable package to the execution environment comprises deploying the website to a server based on the path name assigned to each respective subset of design files.

14. A processing system, comprising:
at least one memory having executable instructions stored thereon; and
one or more processors configured to execute the executable instructions to cause the processing system to:
receive an input prompt specifying a set of design files to convert into an executable package;
partition, by a generative artificial intelligence model, the set of design files into a plurality of subsets of design files, each subset of design files including topically related design files in the set of design files;
generate, by the generative artificial intelligence model, property data for each respective subset of design files;
generate the executable package based on the plurality of subsets of design files and property data associated with each respective subset of design files; and
deploy the executable package to an execution environment.

15. The processing system of claim 14, wherein to partition the set of design files into the plurality of subsets of design files, the one or more processors are configured to cause the processing system to:
generate, using the generative artificial intelligence model, a respective text representation for each respective design file in the set of design files; and
identify matching design files to include in a subset of design files based on determining that a first text representation associated with a first design file in the set of design files and a second text representation associated with a second design file in the set of design files has a similarity metric above a threshold similarity metric.

16. The processing system of claim 14, wherein to partition the set of design files into the plurality of subsets of design files, the one or more processors are configured to cause the processing system to:
generate a matching score between strings in a first design file in the set of design files and a second design file in the set of design files; and
include the first design file and the second design file in a subset of design files based on the matching score between the strings in the first design file and the second design file exceeding a threshold score.

17. The processing system of claim 14, wherein to partition the set of design files into the plurality of subsets of design files, the one or more processors are configured to cause the processing system to:
generate a matching score based on a comparison of visual assets in a first design file and corresponding visual assets in a second design file; and
include the first design file and the second design file in a subset of design files based on the matching score exceeding a threshold score.

18. The processing system of claim 14, wherein to partition the set of design files into the plurality of subsets of design files, the one or more processors are configured to cause the processing system to:
determine that a structure of a first design file is similar to a structure of a second design file; and
include the first design file and the second design file in a subset of design files based on the determining.

19. The processing system of claim 14, wherein to generate the executable package, the one or more processors are configured to cause the processing system, for each respective subset of design files, to:
link matching nodes across design files in the respective subset of design files; and
generate hidden nodes in a first design file in the respective subset of design files corresponding to unmatched nodes in a second design file in the respective subset of design files.

20. A non-transitory computer-readable medium having executable instructions stored thereon which, when executed by one or more processors, performs an operation comprising:
receiving an input prompt specifying a set of design files to convert into an executable package;
partitioning, by a generative artificial intelligence model, the set of design files into a plurality of subsets of design files, each subset of design files including topically related design files in the set of design files;
generating, by the generative artificial intelligence model, property data for each respective subset of design files;
generating the executable package based on the plurality of subsets of design files and property data associated with each respective subset of design files; and
deploying the executable package to an execution environment.
